(19) United States
(12) Patent Application Publication
(10) Pub. No.: US 2026/0166568 A1
(43) Pub. Date: Jun. 18, 2026

(54) ACCESSORY NOZZLE AND HAIR DRYER

(71) Applicant: LG ELECTRONICS INC., Seoul (KR)

(72) Inventor: Doohyun HAN, Seoul (KR)

(21) Appl. No.: 18/854,134

(22) PCT Filed: Dec. 4, 2023
(86) PCT No.: PCT/KR2023/019762

§ 371 Date: Oct. 4, 2024

(30) Foreign Application Priority Data
Jun. 23, 2023 (KR) 10-2023-0081147
Nov. 30, 2023 (KR) 10-2023-0171137

(51) Int. Cl. B05B 1/14; A45D 20/10; A45D 20/12; B05B 1/16; B05B 1/20; B05B 7/06

(52) U.S. Cl. CPC B05B 1/14; A45D 20/10; A45D 20/12; A45D 20/122; B05B 1/16; B05B 1/20; B05B 7/066

(57) ABSTRACT

In an aspect of the present disclosure, provided herein is an accessory nozzle. The accessory nozzle includes: a nozzle frame comprising a fluid inlet for air intake positioned at a rear, a fluid outlet for air discharge positioned at a front, and a nozzle flow path extending from the fluid inlet to the fluid outlet; an exhaust cover coupled to the fluid outlet of the nozzle frame, the exhaust cover comprising a plurality of nozzle holes and a pinhole; a screw boss formed adjacent to the pinhole formed on the exhaust cover; a contact pin passing through the pinhole and protruding forward; and a nozzle screw passing through the nozzle frame and coupled to the screw boss of the exhaust cover.

### TECHNICAL FIELD

The present disclosure relates to a detachable accessory nozzle and hairdryer equipped with the same.

### BACKGROUND

A hair dryer that discharges air through an air outlet may be used to remove as much moisture as desired from wet hair or to style hair from the current shape to a desired shape.

The hair dryer may incorporate internal components such as a fan unit to facilitate the flow of air. The hair dryer with internal components may be designed in consideration of the weight thereof to ensure convenient use for users.

When a heater module is located in a head portion, if the temperature of a case rises due to heat from the heater module, there is a risk of burns. In addition, it may affect internal components such as a controller. Therefore, a structure in which the heat from the heater module is not transferred to the exterior or other components but is entirely transferred to air passing through an air flow path is required.

In particular, for wireless use, the hair dryer needs to have a built-in battery, and additional space need to be secured to accommodate the battery. There is also a need for a hair dryer capable of being equipped with additional components such as an ion generator for expanded functionality and being combined with accessories.

However, since the hair dryer is used while being held in the hand, it is necessary to implement an optimal layout with minimal components to avoid increasing the size or weight when various functions are added.

### DISCLOSURE

### Technical Problem

The present disclosure aims to provide an accessory nozzle for uniformly discharging air through a plurality of nozzle holes and hairdryer equipped with the same.

### Technical Solution

In an aspect of the present disclosure, provided herein is an accessory nozzle. The accessory nozzle includes: a nozzle frame including a fluid inlet for air intake positioned at a rear, a fluid outlet for air discharge positioned at a front, and a nozzle flow path extending from the fluid inlet to the fluid outlet; an exhaust cover coupled to the fluid outlet of the nozzle frame and including a plurality of nozzle holes and a pinhole; a screw boss formed adjacent to the pinhole formed on the exhaust cover; a contact pin passing through the pinhole and protruding forward; and a nozzle screw passing through the nozzle frame and coupled to the screw boss of the exhaust cover.

The contact pin may include an enlarged end portion at a rear end, wherein the enlarged end portion is positioned between the exhaust cover and the nozzle frame. The enlarged end portion may be larger than the pinhole.

The nozzle flow path of the nozzle frame may include: an inclined surface extending forward; and a pin fixing portion protruding on the inclined surface and in contact with a rear surface of the enlarged end portion. The nozzle screw may be fastened adjacent to the pin fixing portion.

The enlarged end portion may include: a first end portion in contact with the inclined surface of the nozzle frame; and a second end portion in contact with the pin fixing portion. An angle between the first end portion and the second end portion is 90 degrees or more.

The contact pin may include: a pin cover made of an elastic material; a mold pin inserted from a rear surface of the pin cover; and a cushion gap formed between a front end of the mold pin and the pin cover.

The nozzle hole may pass through a nozzle protrusion extending forward, and the contact pin may protrude further forward than the nozzle protrusion.

The accessory nozzle may include: a nozzle case coupled to a rear surface of the nozzle frame; a nozzle magnet positioned on the rear surface of the nozzle case; and a magnet screw passing through the nozzle magnet, the nozzle case, and the nozzle frame. The nozzle frame may include a gap rib formed on the rear surface to create a gap with the nozzle case.

The nozzle flow path of the nozzle frame may include: a first flow path having a ring shape and extending forward from the fluid inlet; and a second flow path comprising extending with a step from the first flow path and including an inclined surface extending to the fluid outlet.

The nozzle holes may include: a first nozzle hole positioned at a front of the first flow path; a second nozzle hole positioned more centrally on the exhaust cover than the first nozzle hole; and a third nozzle hole positioned more outward on the exhaust cover than the first nozzle hole. The first nozzle hole may be smaller in size than the second nozzle hole and the third nozzle hole.

The second nozzle hole may be larger than the third nozzle hole, and the second nozzle hole may be fewer in number than the third nozzle hole.

The plurality of nozzle holes may be arranged in concentric circles centered on the exhaust cover, and a spacing between the nozzle holes may decrease from a center towards outer edges.

A center of the exhaust cover may be concavely recessed towards a rear, and the contact pin may be positioned on outer edges of the exhaust cover.

In another aspect of the present disclosure, provided herein is a hair dryer. The hair dryer includes: a main body including an air outlet at a front wherein air is discharged through the air outlet; and an accessory nozzle attached to the air outlet. The accessory nozzle includes: a nozzle frame comprising a fluid inlet for air intake positioned at a rear, a fluid outlet for air discharge positioned at a front, and a nozzle flow path extending from the fluid inlet to the fluid outlet; an exhaust cover coupled to the fluid outlet of the nozzle frame, the exhaust cover comprising a plurality of nozzle holes and a pinhole; a screw boss formed adjacent to the pinhole formed on the exhaust cover; a contact pin passing through the pinhole and protruding forward; and a nozzle screw passing through the nozzle frame and coupled to the screw boss of the exhaust cover.

### Advantageous Effects

An accessory nozzle of the present disclosure may uniformly discharge air through a plurality of nozzle holes.

A contact pin may be stably supported due to the high holding force of the contact pin of the accessory nozzle of the present disclosure, thereby improving the user experience.

Effects obtainable from the present disclosure are not limited by the above mentioned effects, and other unmentioned effects can be clearly understood from the above description by those having ordinary skill in the technical field to which the present disclosure pertains.

### BRIEF DESCRIPTION OF THE DRAWINGS

FIG. 1 is a front perspective view of a hair dryer according to an embodiment of the present disclosure.

FIG. 2 is a rear perspective view of the hair dryer according to an embodiment of the present disclosure.

FIG. 3 is a front perspective view illustrating a state in which a nozzle is attached to a main body of the hair dryer according to an embodiment of the present disclosure.

FIG. 4 is a view illustrating an accessory nozzle according to an aspect of the present disclosure.

FIG. 5 is a cross-sectional view of the accessory nozzle according to an aspect of the present disclosure.

FIG. 6 is an exploded perspective view of the accessory nozzle according to an aspect of the present disclosure.

FIG. 7 is a view illustrating an enlarged end portion of a contact pin and a pin fixing portion of a nozzle frame of the accessory nozzle according to an aspect of the present disclosure.

FIG. 8 is a front view illustrating an exhaust cover of the accessory nozzle according to an aspect of the present disclosure.

FIG. 9 is a graph illustrating the intensity of air discharged through nozzle holes of the accessory nozzle according to an aspect of the present disclosure.

### DETAILED DESCRIPTION

Hereinafter, an embodiment of the present disclosure will be described in detail with reference to the accompanying drawings to be easily implemented by those skilled in the art to which the present disclosure belongs.

However, the present disclosure may be implemented in many different forms and is not limited to embodiments described herein. In addition, in order to clearly describe the present disclosure, components irrelevant to the description are omitted, and like reference numerals are assigned to similar components throughout the specification.

In this specification, duplicate descriptions of the same components are omitted.

Further, in this specification, it will be understood that when a component is referred to as being “connected with” another component, the component may be directly connected with the other component or intervening components may also be present. In contrast, it will be understood that when a component is referred to as being “directly connected with” another component in this specification, there are no intervening components present.

Further, in this specification, the terminology used herein is for the purpose of describing a specific embodiment only and is not intended to be limiting of the present disclosure.

Further, in this specification, the singular forms “a” and “an” are intended to include the plural forms as well, unless the context clearly indicates otherwise.

Further, in this specification, it will be further understood that the terms “comprises,” “comprising,” “includes,” and “including” specify the presence of the certain features, numbers, steps, operations, elements, and parts or combinations thereof, but do not preclude the presence or addition of one or more other features, numbers, steps, operations, elements, and parts or combinations thereof.

Further, in this specification, the term ‘and/or’ includes a combination of a plurality of listed items or one of the plurality of listed items. In this specification, ‘A or B’ may include ‘A,’ ‘B,’ or ‘both A and B.’

The present disclosure relates to a portable device capable of being used handheld by a user and, more particularly, to an electronic device that is small in size and designed to be used handheld by a user. Since the portable device is not used in a stationary position but rather is held and used directly by the user, the portable device needs to be lightweight, and the grip comfort of a handle 102 is important. Additionally, because the portable device is prone to contamination from external substances, a waterproof feature may be necessary.

The portable device of the present disclosure relates to beauty devices. For example, the portable device relates to a hair dryer 100. While the present disclosure is described based on the hair dryer 100, the present disclosure is not limited thereto. Portable devices such as handheld skincare devices or body care devices may also be included in the scope of the present disclosure.

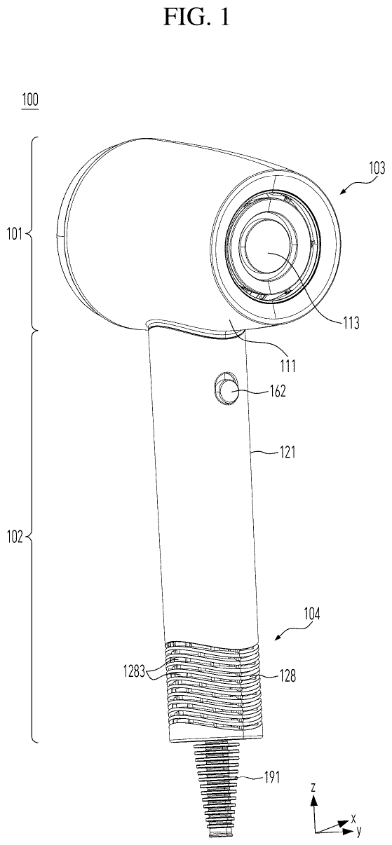

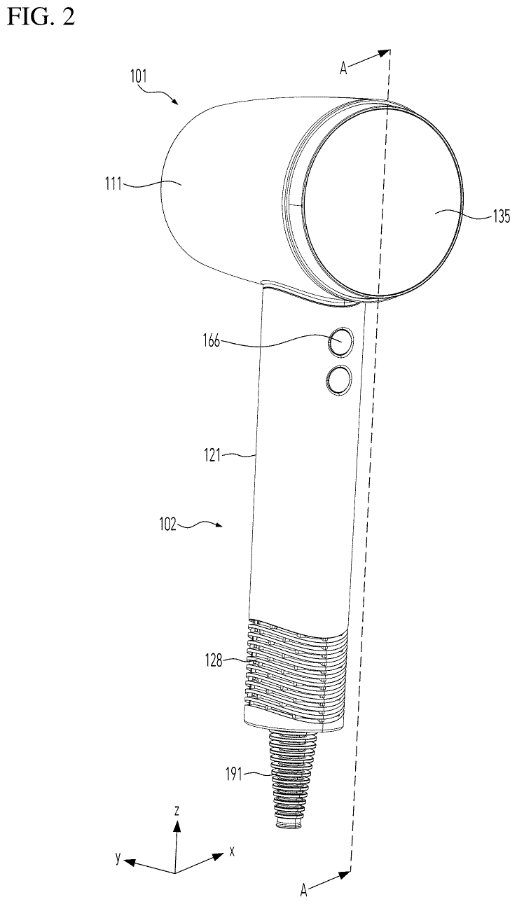

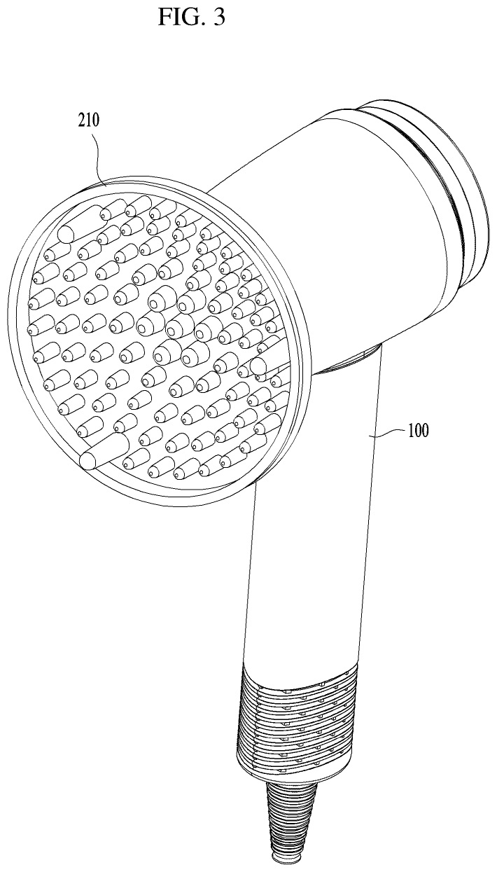

FIG. 1 is a front perspective view of the hair dryer 100 according to an embodiment of the present disclosure. FIG. 2 is a rear perspective view of the hair dryer 100 according to an embodiment of the present disclosure. FIG. 3 is a cross-sectional view of the hair dryer 100 according to an embodiment of the present disclosure, taken along line A-A of FIG. 2.

In the drawings, the x-axis represents the left-right direction, the y-axis represents the front-back direction, and the z-axis represents the up-down direction. When viewed from the front, +x is to the right when viewed from the front, −x is to the left. Further, +y is forward, −y is backward, +z is upward, and −z is downward.

The hair dryer 100 according to an embodiment of the present disclosure includes a main body including a head portion 101 and a handle portion 102. The handle portion 102 includes an air inlet 104 through which air is drawn from the outside at the bottom thereof, and the head portion 101 includes an air outlet 103 from which air is discharged.

The interior of the main body 101 and 102 of the hair dryer 100 includes an airflow path extending from the air inlet 104 to the air outlet 103. The airflow path of the present disclosure is not a straight path. Specifically, the airflow path moves vertically at the handle portion 102 and then bends horizontally at the head portion 101.

The air inlet 104 may be located at the bottom of the handle portion 102, and the air outlet 103 may be located at the front of the head portion 101. The handle portion 102 and the head portion 101 have shapes corresponding to the direction in which the airflow path extends. For usability, the handle portion 102 may extend in a direction slightly tilted forward from the vertical direction with respect to the head portion 101.

The handle portion 102 may be formed as a cylinder with a diameter that capable of being gripped by the user, and the head portion 101 may be formed as a cylinder with a larger diameter than the handle portion 102. The diameter of the handle portion 102 may be uniform from the bottom to the top, but the head portion 101 may have a slightly smaller diameter at the front to guide air towards the air outlet 103.

The air inlet 104 may include air intake holes 1283 formed around the circumference of the handle portion 102 and a filter to prevent the ingress of other foreign substances such as dust. A filter frame on which the filter 1293 is fixed may be located at the bottom of the handle portion 102 to form the air inlet 104. A filter cover 128 for protecting the filter may be further included.

The air outlet 103 is located at the front of the head portion 101 and may include a circular opening. The heating coil of a heater module of the present disclosure has a donut shape with an empty central part, and the air outlet 103 may also have a ring shape related thereto.

FIG. 3 illustrates a state in which a nozzle 200 is attached to the main body. To change the way that air is discharged as desired by the user, various types of nozzles 200 may be attached to and detached from the air outlet 103.

A ring-shaped opening such as the air outlet 103 in FIG. 1 allows air to come out over a wide area, and thus the ring-shaped opening is convenient for drying hair. However, for purposes such as styling or scalp care, it is advantageous to change a pattern in which air is discharged.

Thus, the detachable nozzle 200 may be used to change the air discharge pattern according to the intended use. Since the central part of the air outlet 103 is an area where air is not discharged, a nozzle attachment portion 113 may be placed thereon. A head magnet 1132 that attaches to the nozzle 200 may be positioned in the nozzle attachment portion 113.

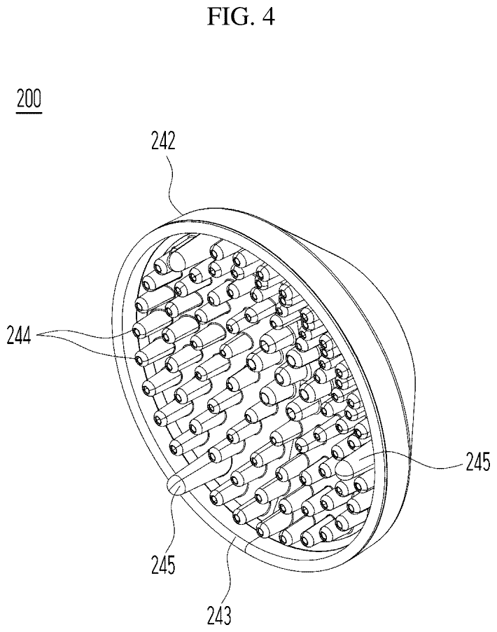

FIG. 4 is a view illustrating an accessory nozzle 200 according to an aspect of the present disclosure. In this embodiment, the accessory nozzle 200 may include an exhaust cover 243 with a plurality of nozzle holes 244 formed on the front side, as a scalp drying nozzle capable of evenly supplying air to the scalp for drying the scalp. The front of the accessory nozzle 200 is larger than the rear thereof.

To direct the air discharged from the nozzle hole 244 forward, the nozzle hole 244 may be elongated forward. To ensure that the nozzle hole 244 is not in direct contact with the scalp but is positioned at a certain distance, a contact pin 245 that directly touches the scalp may protrude more than the nozzle hole 244.

To dry the scalp, the hair dryer adheres closely to the head, the exhaust cover 243 of the accessory nozzle 200 of the present disclosure may have a concave center and include a curved surface with a specified curvature.

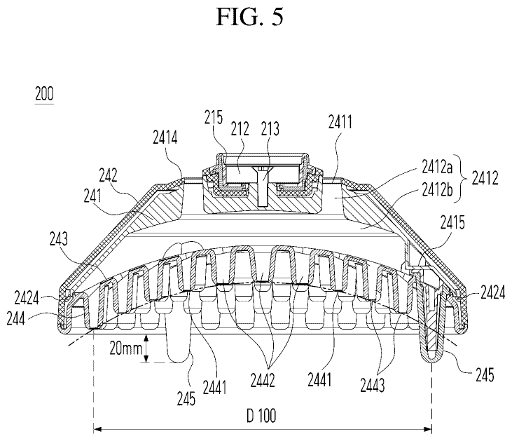

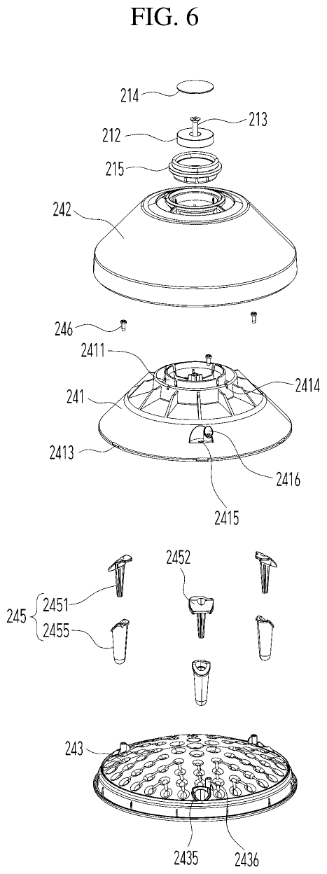

FIG. 5 is a cross-sectional view of the accessory nozzle 200 according to an aspect of the present disclosure. FIG. 6 is an exploded view of the accessory nozzle 200 according to an aspect of the present disclosure. Hereinafter, each component of the accessory nozzle 200 will be described in detail.

The accessory nozzle 200 includes a nozzle frame 241 including a rear fluid inlet 2411, a front fluid outlet 2413, and a nozzle flow path 2412 connecting the fluid inlet 2411 and the fluid outlet 2413. The nozzle frame 241 may have a cone shape widening towards the front as illustrated in FIGS. 5 and 6.

The rear fluid inlet 2411 forms a ring shape corresponding to the shape of the air outlet of the hair dryer 100, and the fluid outlet 2413 may widen to a larger circular shape than the fluid inlet 2411. The nozzle flow path 2412, as shown in FIG. 5, may include a first flow path 2412a that forms a straight section from the fluid inlet 2411 to the front and a second flow path 2412b that transitions from a donut shape of the first flow path 2412a to a circular shape and expanding towards the front.

If only the second flow path 2412b that expands directly forward is included without the first flow path 2412a, the discharged air may have weak straightness, causing turbulence and potentially reducing the intensity of the discharged air. Additionally, there may be a need for a space for the arrangement of a nozzle magnet 212 for attachment to the nozzle attachment portion of the hair dryer 100. Therefore, the nozzle flow path 2412 may include the straight section continuing from the fluid inlet 2411, which is the first flow path 2412a.

The exhaust cover 243 covering the fluid outlet 2413 of the nozzle frame 241 includes a plurality of nozzle holes 244. In this embodiment, the contact pin 245 may include a pin penetrating through a pinhole 2435 formed in the exhaust cover 243 as illustrated in FIG. 6, rather than being integrally formed with the exhaust cover 243.

The contact pin 245 protrudes forward more than the nozzle hole 244 to ensure that the hair dryer is positioned at a certain distance from the user scalp with no direct contact with the user scalp. Since the contact pin 245 is in direct contact with the user scalp, the contact pin 245 may include a pin cover 2455 made of an elastic material. In addition, the contact pin 245 may internally include a pin cover 2455 made of an injection-molded material for rigidity.

For cushioning, a space (cushion gap) may be formed between the front end of a molded pin 2451 and the pin cover 2455. The contact pin 245 may include an enlarged end portion 2452 larger than the pinhole 2435. The front end of the contact pin 245 protrudes forward through the pinhole 2435 of the exhaust cover 243, while the enlarged end portion 2452 may catch on the pinhole 2435 of the exhaust cover 243 and be positioned between the exhaust cover 243 and the nozzle frame 241.

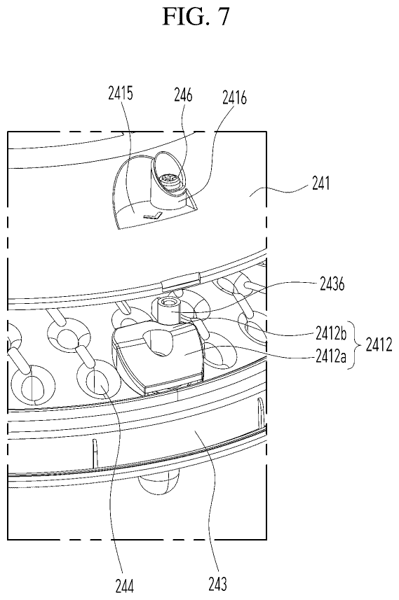

FIG. 7 is a view illustrating the enlarged end portion 2452 of the contact pin 245 and a pin fixing portion 2415 of the nozzle frame 241 of the accessory nozzle 200 according to one aspect of the present disclosure. A screw boss 2436 may be positioned adjacent to the pinhole 2435 of the exhaust cover 243.

The screw boss 2436 is fastened with the rear to the front by the nozzle screw 246 from the rear to the front, which fastens the nozzle frame 241 and the exhaust cover 243. As shown in FIG. 5, the nozzle frame 241 and the exhaust cover 243 are spaced a predetermined distance apart to form the nozzle flow path 2412. However, the nozzle frame 241 and the exhaust cover 243 are in contact with each other in a portion where the screw boss 2436 is located.

The portion where the screw boss 2436 of the exhaust cover 243 is located may be supported by the nozzle frame 241 even if pressed from the rear. Therefore, to support the contact pin 245, which directly touches the scalp and is subjected to force in the rear direction, the screw boss 2436 and the pinhole 2435 may be arranged adjacent to each other.

To further reduce the distance between the center of the contact pin 245 and the screw boss 2436, a portion of the enlarged end portion 2452 corresponding to the screw boss 2436 may be omitted.

As shown in FIG. 4, the contact pin 245 may be positioned on the outer edge of the exhaust cover 243. Therefore, the enlarged end portion 2452 may include a first end portion 2452a in contact with a conical inclined surface of the nozzle frame 241.

However, since the contact pin 245 is subjected to force from the front to the rear, it is necessary to support the contact pin 245 in a direction perpendicular to the direction in which the contact pin 245 is pressed to more effectively support the contact pin 245.

The nozzle frame 241 includes a pin fixing portion 2415 that protrudes forward in a portion where the contact pin 245 is located, and the pin fixing portion 2415 faces a direction perpendicular to the rear where the pin is pressed. Accordingly, the enlarged end portion 2452 may also include a second end portion 2452b in contact with the pin fixing portion 2415.

The first end portion 2452a and the second end portion 2452b form an angle of more than 90° and may support the contact pin 245 by making contact with an inclined sidewall of the nozzle flow path 2412 of the nozzle frame 241 and the pin fixing portion 2415. The nozzle screw 246 passes through a screw hole 2156 adjacent to the pin fixing portion 2415 of the nozzle frame 241 and is fastened to the screw boss 2436. The nozzle screw 246 may fix the contact pin 245 while simultaneously securing the exhaust cover 243 and the nozzle frame 241.

Referring again to FIG. 5, a nozzle case 242, which covers the rear surface of the nozzle frame 241, blocks the heat of hot air passing through the nozzle flow path 2412 of the nozzle frame 241 from being transferred to the outside. To prevent heat transfer, the nozzle frame 241 and the nozzle case 242 may be coupled together while forming a predetermined gap g (see FIG. 5).

To maintain the gap g between the nozzle frame 241 and the nozzle case 242, the nozzle frame 241 may include a gap rib 2414 protruding from the rear.

A nozzle magnet 212 may be positioned at the center of the ring-shaped fluid inlet 2411. The nozzle magnet 212 may include a silicone guide 215 with elasticity, which guides a coupling position with the nozzle attachment portion 113 of the hair dryer 100 while preventing damage to the nozzle attachment portion 113 of the hair dryer 100.

A magnetic screw 213 passing through the nozzle magnet 212 may penetrate the nozzle magnet 212, the silicon guide 215, and the nozzle case 242 and be fastened to the nozzle frame 241. The rear end of the nozzle case 242 may be fixed by the magnet screw 213, and the front end of the nozzle case 242 may be fastened to the nozzle frame 241 based on a hook structure 2424 formed around the front circumference.

Referring to FIG. 5, the air diffused along the second flow path 2412b may be discharged through the nozzle hole 244 of the exhaust cover 243, which is connected to a flow path exit. The nozzle hole 244 may extend forward from the exhaust cover 243 to form a nozzle protrusion.

The air redirected into the nozzle hole 244 from the second flow path 2412b may be discharged forward through the straight section of the nozzle hole 244. Additionally, the front end of the nozzle hole 244 is smaller front than the rear end, which may enhance the speed of the air discharged through the nozzle hole 244.

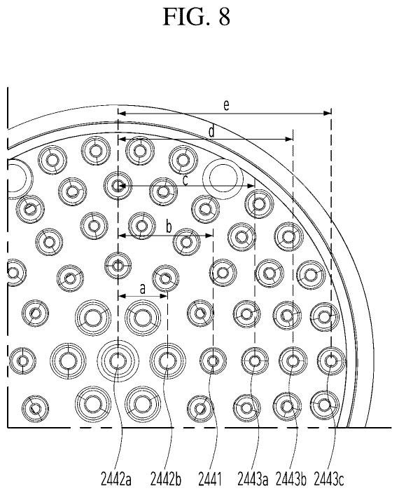

FIG. 8 is a front view illustrating the exhaust cover 243 of the accessory nozzle 200 according to one aspect of the present disclosure. As shown in FIG. 8, the nozzle holes 244 of the present disclosure may be arranged in concentric circles. There may be a single nozzle hole 244 at the center, and more nozzle holes 244 may be arranged towards the outer edges. The spacing between the concentric circles may become closer towards the outer side.

As shown in FIG. 5, a first nozzle hole 2441 positioned in a straight line with the fluid inlet 2411 may be included, a second nozzle hole 2442 located radially inward (towards the center) from the first nozzle hole 2441 may be included, and a third nozzle hole 2443 located radially outward (towards the edge) from the first nozzle hole 2441 may be included.

The first nozzle hole 2441 is positioned at a location where the air entering from the fluid inlet 2411 reaches in the shortest distance. Thus, the intensity and volume of the air may be the highest. Therefore, the size of the first nozzle hole 2441 may be made smaller than that of the second nozzle hole 2442 and the third nozzle hole 2443.

As shown in FIG. 5, the center of the exhaust cover 243 is concavely recessed in the rear direction. Therefore, the air discharged through the second nozzle hole 2442 located in the center may be discharged after moving in the opposite direction to the original path. The air discharged through the second nozzle hole 2442 may have a lower volume and intensity, and thus the second nozzle hole 2442 may be made the largest in size.

The third nozzle hole 2443 is larger than the first nozzle hole 2441, but the third nozzle hole 2443 is smaller than the second nozzle hole 2442 and more numerous. As the third nozzle hole 2443 is farther from the flow path inlet towards the outer side, a third nozzle hole 2443 located in the outermost concentric row may be the largest in size among a plurality of third nozzle holes 2443.

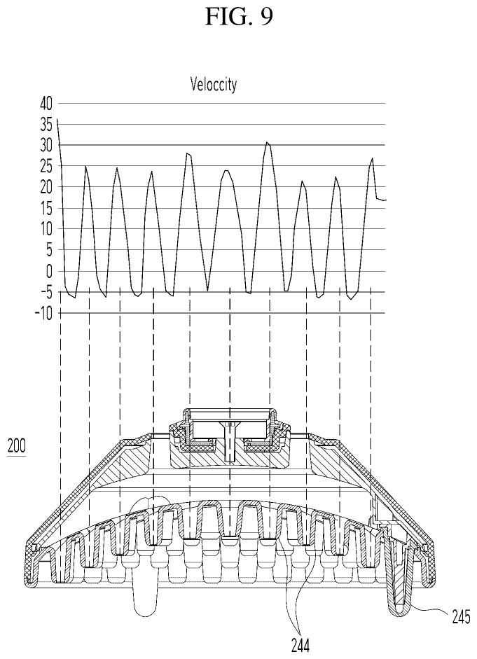

FIG. 9 is a graph illustrating the intensity of air discharged through the nozzle hole 244 of the accessory nozzle 200 according to one aspect of the present disclosure. As described above, the accessory nozzle 200 equipped with the nozzle holes 244 that are configured with different sizes and placements based on the position of the flow path inlet may have relatively consistent air intensity across each nozzle hole 244.

As described above, the accessory nozzle of the present disclosure allows air to be uniformly discharged through the plurality of nozzle holes 244.

Additionally, the contact pin 245 may be stably supported due to the high holding force of the contact pin 245 of the accessory nozzle of the present disclosure, thereby improving the user experience.

Although a specific embodiment of the present disclosure has been illustrated and described above, those of ordinary skill in the art to which the present disclosure pertains will appreciate that various modifications are possible within the limits without departing from the technical spirit of the present disclosure provided by the following claims.

1. An accessory nozzle comprising:
a nozzle frame comprising a fluid inlet for air intake positioned at a rear, a fluid outlet for air discharge positioned at a front, and a nozzle flow path extending from the fluid inlet to the fluid outlet;
an exhaust cover coupled to the fluid outlet of the nozzle frame, the exhaust cover comprising a plurality of nozzle holes and a pinhole;
a screw boss formed adjacent to the pinhole formed on the exhaust cover;
a contact pin passing through the pinhole and protruding forward; and
a nozzle screw passing through the nozzle frame and coupled to the screw boss of the exhaust cover.

2. The accessory nozzle of claim 1, wherein the contact pin comprises an enlarged end portion at a rear end, wherein the enlarged end portion is positioned between the exhaust cover and the nozzle frame, and
wherein the enlarged end portion is larger than the pinhole.

3. The accessory nozzle of claim 2, wherein the nozzle flow path of the nozzle frame comprises:
an inclined surface extending forward; and
a pin fixing portion protruding on the inclined surface and in contact with a rear surface of the enlarged end portion, and
wherein the nozzle screw is fastened adjacent to the pin fixing portion.

4. The accessory nozzle of claim 3, wherein the enlarged end portion comprises:
a first end portion in contact with the inclined surface of the nozzle frame; and
a second end portion in contact with the pin fixing portion,
wherein an angle between the first end portion and the second end portion is 90 degrees or more.

5. The accessory nozzle of claim 2, wherein the contact pin comprises:
a pin cover made of an elastic material;
a mold pin inserted from a rear surface of the pin cover; and
a cushion gap formed between a front end of the mold pin and the pin cover.

6. The accessory nozzle of claim 1, wherein the nozzle hole passes through a nozzle protrusion extending forward, and
wherein the contact pin protrudes further forward than the nozzle protrusion.

7. The accessory nozzle of claim 1, comprising:
a nozzle case coupled to a rear surface of the nozzle frame;
a nozzle magnet positioned on the rear surface of the nozzle case; and
a magnet screw passing through the nozzle magnet, the nozzle case, and the nozzle frame,
wherein the nozzle frame comprises a gap rib formed on the rear surface to create a gap with the nozzle case.

8. The accessory nozzle of claim 1, wherein the nozzle flow path of the nozzle frame comprises:
a first flow path having a ring shape and extending forward from the fluid inlet; and
a second flow path extending with a step from the first flow path, the second flow path comprising an inclined surface extending to the fluid outlet.

9. The accessory nozzle of claim 8, wherein the nozzle holes comprise:
a first nozzle hole positioned at a front of the first flow path;
a second nozzle hole positioned more centrally on the exhaust cover than the first nozzle hole; and
a third nozzle hole positioned more outward on the exhaust cover than the first nozzle hole,
wherein the first nozzle hole is smaller in size than the second nozzle hole and the third nozzle hole.

10. The accessory nozzle of claim 9, wherein the second nozzle hole is larger than the third nozzle hole, and
wherein the second nozzle hole is fewer in number than the third nozzle hole.

11. The accessory nozzle of claim 1, wherein the plurality of nozzle holes are arranged in concentric circles centered on the exhaust cover, and
wherein a spacing between the nozzle holes decreases from a center towards outer edges.

12. The accessory nozzle of claim 1, wherein a center of the exhaust cover is concavely recessed towards a rear, and
wherein the contact pin is positioned on outer edges of the exhaust cover.

13. A hair dryer comprising:
a main body comprising an air outlet at a front, wherein air is discharged through the air outlet; and
an accessory nozzle attached to the air outlet, the accessory nozzle comprising:
a nozzle frame comprising a fluid inlet for air intake positioned at a rear, a fluid outlet for air discharge positioned at a front, and a nozzle flow path extending from the fluid inlet to the fluid outlet;
an exhaust cover coupled to the fluid outlet of the nozzle frame, the exhaust cover comprising a plurality of nozzle holes and a pinhole;
a screw boss formed adjacent to the pinhole formed on the exhaust cover;
a contact pin passing through the pinhole and protruding forward; and
a nozzle screw passing through the nozzle frame and coupled to the screw boss of the exhaust cover.
